(19) United States
(12) Patent Application Publication
(10) Pub. No.: US 2016/0223089 A1
(43) Pub. Date: Aug. 4, 2016

(54) Choke Valve Wear Monitoring System and Method

(71) Applicant: Pentair Flow Services AG, Schaffhausen (CH)

(72) Inventor: Jan Willem Nijland, Rijssen (NL)

(21) Appl. No.: 15/009,227

(22) Filed: Jan. 28, 2016

Related U.S. Application Data
(60) Provisional application No. 62/110,176, filed on Jan. 30, 2015.

(51) Int. Cl. F16K 3/04; F16K 37/00

(52) U.S. Cl. CPC F16K 3/04; F16K 37/0091

(57) ABSTRACT

Embodiments of the invention provide a choke valve that includes a valve body, a stationary disc, a rotating disc, an actuator system, and a wear monitoring system. The valve body defines an inlet and an outlet. The stationary disc includes a bean and defines a passageway arranged between the inlet and outlet of the valve body. The rotating disc is arranged adjacent the stationary disc and is movable between an open position and a closed position. The actuator system is coupled to the rotating disc and is arranged to actuate the rotating disc between the open position and the closed position. The wear monitoring system includes a port in communication with a depressurized cavity formed between the valve body and the bean, and a pressure sensor that monitors a pressure in the depressurized cavity.

### RELATED APPLICATIONS

This application claims priority to U.S. Provisional Patent Application No. 62/110,176 filed on Jan. 30, 2015, the entire contents of which are incorporated herein by reference.

### BACKGROUND

Choke valves are commonly used in the oil and gas industries, as well as mining industries, as part of an arrangement of valves and fittings that extend above the well head. In general, choke valves include a valve body having an axial bore, a body inlet (typically referred to as a side outlet) and a body outlet (typically referred to as an end outlet); a “flow trim” mounted in the bore between the inlet and the outlet, for throttling the flow moving through the body; and a mechanism for actuating the flow trim to close the end of the bore remotely from the outlet.

There are four main types of flow trims commonly used in commercial choke valves. Each flow trim involves a port-defining member, a movable member for throttling the port, and a seal for implementing a total shut-off. These four types of flow trim can be characterized as follows: (1) a needle-and-seat flow trim comprising a tapered annular seat fixed in the valve body and a movable tapered internal plug for throttling and sealing in conjunction with the seat surface; (2) a cage-with-internal-plug flow trim comprising a tubular, cylindrical cage, fixed in the valve body and having ports in its side wall, and a plug movable axially through the bore of the cage to open or close the ports with shut-off generally accomplished with a taper on the leading edge of the plug, which seats on a taper carried by the cage or a body downstream of the ports; (3) a multiple-port-disc flow trim comprising a fixed ported disc mounted in the valve body and a contiguous rotatable ported disc that can be turned to cause the two sets of ports to move into or out of register for throttling and shut-off; and (4) a cage-with-external-sleeve flow trim comprising a tubular cylindrical cage having ports in its side wall and a hollow cylindrical sleeve that slides axially over the cage to open and close the ports. The shut-off is accomplished with the leading edge of the sleeve contacting an annular seat carried by the valve body or cage.

In each of the above, the flow trim is positioned within the choke valve at the intersection of the choke valve's inlet and outlet. In most of the valves, the flow trim includes a stationary tubular cylinder referred to as a “cage” positioned transverse to the inlet and having its bore axially aligned with the outlet. The cage has restrictive flow ports extending through its sidewall. Fluid enters the cage from the choke valve inlet, passes through the ports, and changes direction to leave the cage bore through the valve outlet. This type of a flow trim also includes a tubular throttling sleeve that slides over the cage. The sleeve acts to reduce or increase the area of the ports. An actuator, such as a threaded stem assembly, is provided to bias the sleeve back and forth along the cage. The rate that fluid passes through the flow trim is dependent on the relative position of the sleeve on the cage and the amount of port area that is revealed by the sleeve.

Regardless of the flow trim configuration, the above described choke valves can be used to reduce the pressure of the fluid flowing from a well, for example, from a normally high pressure value to a lower pressure value. The pressure drop is accomplished in the choke valve by varying the cross-sectional area of the fluid flow stream to form a restriction for those fluids flowing from the well head.

The fluid stream flowing from an oil or gas well typically contains material which can be chemically corrosive and/or mechanically erosive to the choke valve. For example, the fluid stream can contain sand, and/or particulate material, as well as acids and corrosive harmful chemicals. Chemical corrosion and mechanical erosion are problems which have long plagued choke valve constructions. Many applications, such as oil and gas well installations, are in remote locations where a daily inspection of the choke valve is difficult or impossible. In these situations, undetected wear can create a valve failure situation, which can be not only damaging to the choke valve, but dangerous and possibly catastrophic. If the choke valve becomes eaten away because of corrosion or erosion, leakage of gas and/or oil could occur.

In the past, various types of liners were used to protect choke valves from erosion and corrosion. The prior attempts, which did not provide satisfactory results, included such components as pistons, sleeves, cages, plating or linings of tungsten carbide, chrome stainless, Stellite and ceramics. Typically, the liner was placed directly upon the housing or body of the choke. When the wear sleeve or liner was fully eroded or corroded by the flowing media, damage to the choke valve body was immediate. This type of damage to the choke valve body required extensive repair, which necessitated removal of the choke valve from the installation for repair at a machine shop.

Additionally, or alternatively, pressure and temperature transmitters have been installed into the flow lines upstream and downstream of the choke valve to determine whether the flow trim has been worn beyond its useful life. The sensor information is then sent to a remote location for monitoring, so that a choke valve controller can remotely bias the flow trim to affect the desired flow rate. The controller sends electrical signals to a mechanism associated with the choke valve for adjusting the flow trim. However, a problem exists with this process due to the unreliable nature of these electronic sensors, which have a limited service life. Replacing the sensors after they have served their useful life has required that the whole wellhead assembly be raised to the surface. This is a time-consuming and costly operation that shuts down well production for the duration of the repair.

### SUMMARY

There is a need for a choke valve capable of detecting erosion on time by monitoring the wear status. Once erosion is detected, it would be desirable to keep the choke valve in line and only replace internal parts. In addition, there is a need for a tight shut off of the choke valve under the conditions of high differential pressure and flows of polluted fluids.

Embodiments of the invention overcome these problems by providing a wear monitoring system that is incorporated into a choke valve to detect erosion. The wear monitoring system provides a pressure sensor to detect a pressure increase in a depressurized cavity. The wear monitoring system ensures that only internal components (e.g., a rotating disc and a bean) need to be replaced if erosion occurs while the choke valve remains in service. Thus, the valve body is less affected by erosion, as is typically seen in choke valves, because the medium (e.g., fuel) is not filtered, causing wear and tear on the outlet piping. In addition, the choke valve improves laminar and non-turbulent flow through to limit erosion on the outlet piping.

In some embodiments, the wear monitoring system can include a pressure sensor, an outer depressurized cavity, a first cavity seal, and a second cavity seal. The pressure sensor can extend through a pressure port positioned above of the valve body to measure pressure within the depressurized cavity. The pressure port extends from an exterior environment of the choke valve to the depressurized cavity. The depressurized cavity can be defined by the space between the inner surface of the valve outlet and an outer surface of a bean. The first cavity seal is positioned between the inner surface of the outlet and the outer surface of the bean to seal off a bottom portion of the depressurized cavity. Similarly, the second cavity seal circumscribes the outer surface of a stationary disc to seal off a top portion of the depressurized cavity. If the pressure sensor detects a pressure greater than a predetermined threshold value, a signal is sent to close the choke valve and emergency shutdown (ESD) valves. This increase in pressure indicates that erosion has caused washing of the bean, resulting in the depressurized cavity becoming pressurized. A signal can then be sent from the pressure sensor to a remote user interface, for example, to alert a user that the choke valve requires service. The wear monitoring system ensures laminar and non-turbulent flow to limit erosion on the outlet piping by providing a larger diameter outlet than a passageway through the bean.

In other embodiments, a choke valve is provided that includes a valve body defining an inlet and an outlet. The choke valve further includes a stationary disc including a bean and defining a passageway arranged between the inlet and outlet of the valve body. A rotating disc is arranged adjacent the stationary disc, and the rotating disc is movable between an open position and a closed position. An actuator system is coupled to the rotating disc and arranged to actuate the rotating disc between the open position and the closed position. The choke valve further comprises a wear monitoring system that includes a port in communication with a depressurized cavity formed between the housing and the bean, and a pressure sensor monitoring the pressure in the depressurized cavity.

In other embodiments, a choke valve is provided that includes a valve body housing that defines an inlet and an outlet. The outlet defines an outlet diameter. A rotating disc is arranged between the inlet and the outlet and can be moved between an open position and a closed position, and a bean is positioned adjacent to and downstream of the rotating disc. The bean includes a passageway that defines a passageway diameter. A ratio of the outlet diameter to the passageway diameter is between about 1.3 and about 35.

In other embodiments, a choke valve is provided that includes a valve body housing that defines an inlet and an outlet. A rotating disc is arranged between the inlet and the outlet and can be moved between an open position and a closed position, and a bean is positioned adjacent to and downstream of the rotating disc and includes a passageway that defines a passageway diameter and a passageway length. A ratio of the passageway length to the passageway diameter is between about 5 and about 15.

These and other features, aspects, and advantages of the invention will become better understood upon consideration of the following detailed description, drawings, and appended claims.

### DESCRIPTION OF THE DRAWINGS

FIG. 1 is a partial cross-sectional view of a choke valve including a wear monitoring system according to one embodiment of the invention.

FIG. 2 is a cross-sectional view of the choke valve including the wear monitoring system of FIG. 1.

FIG. 3 is an enlarged cross-sectional view of the wear monitoring system of FIG. 2.

FIGS. 4A-4C is a schematic of a rotating disc and a stationary disc of the choke valve shown in an open, throttled, and shut position relative to each other.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

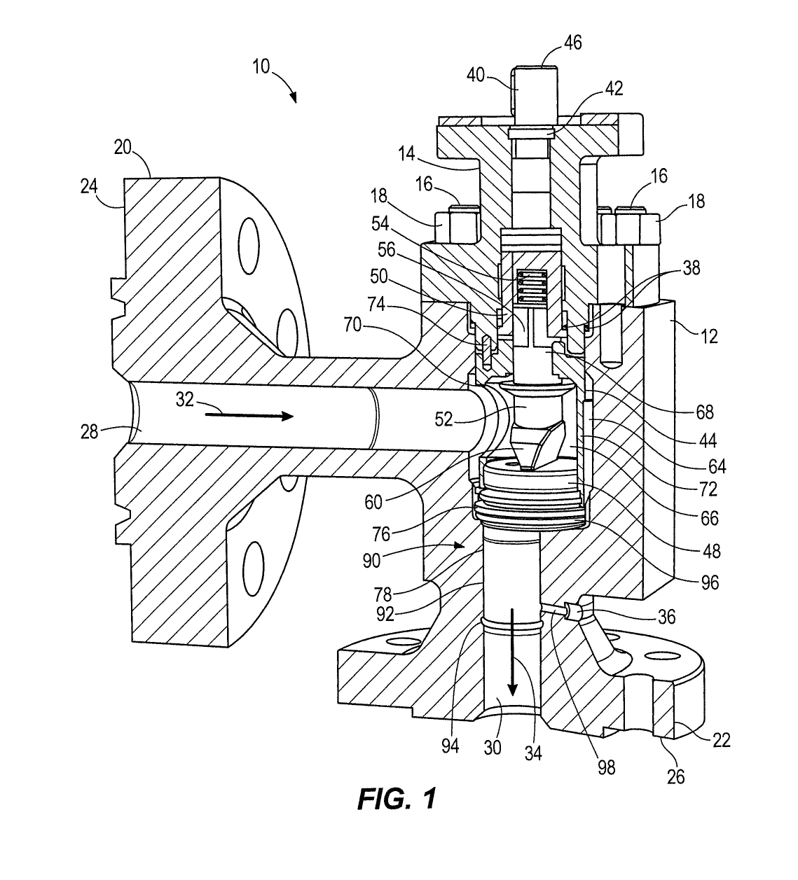

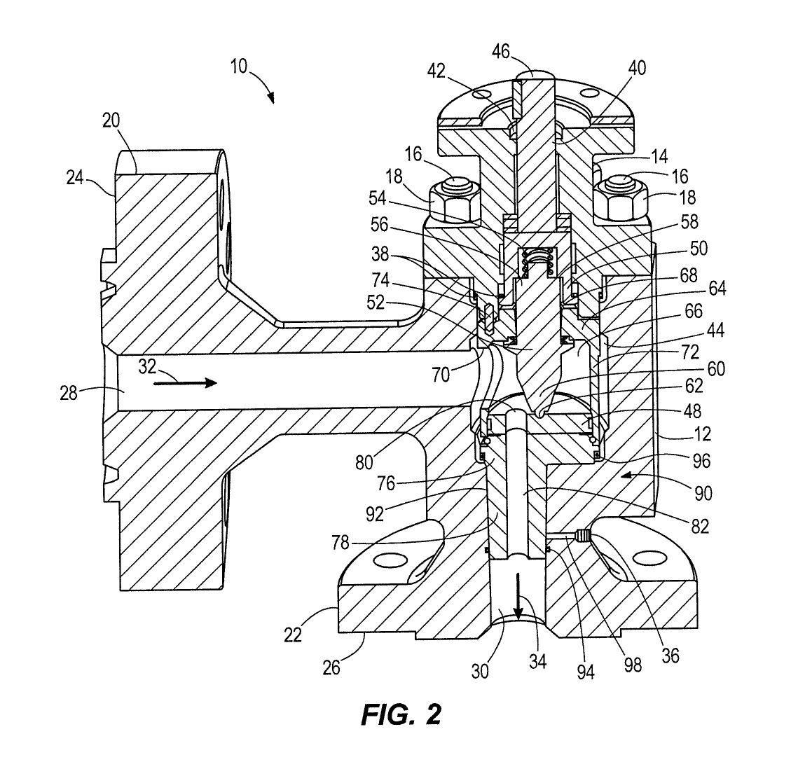

FIGS. 1 and 2 illustrate a choke valve 10 according to one embodiment of the invention. The choke valve 10 can include a valve body 12 and a valve bonnet 14 that is releasably secured in a flanged manner by equi-circumferentially spaced helically threaded bolts 16 receiving rotatable receiving nuts 18. The choke valve 10 shown in FIGS. 1-3 is an angled body choke valve; however, the choke valve can be of the inline Y-type body or inline body, for example.

The valve body 12 can include an upstream flange 20 and a downstream flange 22. Each flange 20, 22 provides a flange face 24, 26 respectively that typically aligns with a similar flange of another, valve, or other section of pipeline, or such ancillary equipment as is commonly found at a well head or other valve assembly, for example. The valve body 12 also includes a flow annulus including an upstream inlet 28 and a downstream outlet 30 with arrows 32, 34 showing the direction of flow through the valve body 12 beginning with the upstream flow arrow 32 and continuing to the downstream flow arrow 34. The downstream outlet 30 is equipped with a pressure sensor 36 for detecting erosion, as the downstream outlet 30 is normally encountered with high velocity flow and is an area subject to erosion and/or corrosion, as will be described in further detail below.

The bonnet 14 can be coupled to the valve body 12 via the bolts 16 and nuts 18. One or more seals 38 can be provided where the valve body 12 contacts the bonnet 14 to inhibit fluid leakage from the choke valve 10. A shaft 40 can extend through an opening 42 of the bonnet 14 into a component chamber 44 of the valve body 12. At a distal end 46, the shaft 40 can be coupled to an actuator (not shown) to actuate the choke valve 10. The actuator can be, for example, a pneumatic, hydraulic, electric, hand knob, hand wheel, or hand lever type actuator that, when coupled to the shaft 40, provides rotation to a rotating disc 48. At an opposing end 50, the shaft 40 can be coupled to a turning fork 52 that engages the rotating disc 48. In addition, a spring 54 can be provided between the shaft 40 and the turning fork 52 to pre-load the rotating disc 48, allowing the choke valve 10 to be mounted in any position. The spring 54 can also absorb thermal expansion due to temperature changes and vibrations, for example.

At a first end 56, the turning fork 52 can be dimensioned to be received within the opposing end 50 of the shaft 40. The first end 56 of the turning fork 52 can be square or hex shaped, for example, and received by a similar square or hex shaped opening in the opposing end 50 of the shaft 40. When the shaft 40 is rotated, the turning fork 52 rotates as well. As shown in FIG. 2, the first end 56 of the turning fork 52 abuts a seat 58 provided within the opposing end 50 of the shaft 40, restricting vertical movement, but allowing rotational movement of the turning fork 52. A second end 60 of the turning fork 52 can be wedged or key shaped, for example, to engage a corresponding slot 62 on the surface of the rotating disc 48. When the shaft 40 rotates, the turning fork 52 provides a corresponding rotational force to the rotating disc 48.

As also shown in FIGS. 1 and 2, a protective bushing 64 can be provided in the component chamber 44 of the valve body 12. The protective bushing 64 can be substantially cylindrical in shape and define an interior hollow cavity 66. A centrally disposed aperture 68 can extend from a top portion of the protective bushing 64 into the interior cavity 66 and is configured to receive the turning fork 52. Another aperture 70 is disposed on a side wall 72 of the bushing 64 and aligned with the inlet 28 to allow the medium to flow into the hollow cavity 66. Also housed within the hollow cavity 66 of the bushing 64 is the rotating disc 48. As the turning fork 52 and rotating disc 48 rotate within the hollow cavity 66, the bushing 64 reduces friction and wear between the rotating parts, as well as constrains the motion of the parts. A pin 74 can extend between the bushing 64 and the bonnet 14 to ensure the bushing 64 remains stationary.

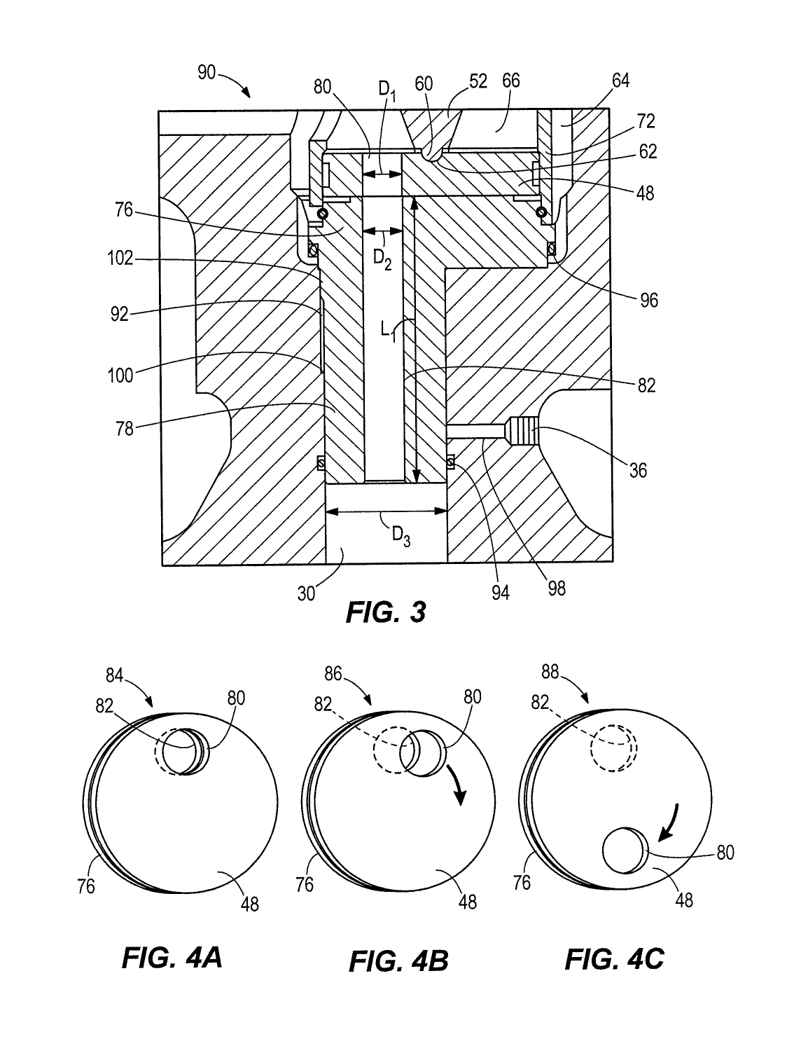

Downstream from the rotating disc 48 is a stationary disc 76 integrally coupled to a bean 78 that extends into the outlet 30 of the valve body 12. The bean 78 provides restriction as is well known in the art. In one embodiment, the bean 78 can be an abrasion resistant tungsten carbide bean, which removes the majority of corrosion and erosion from the sealing surfaces and valve body 12. As shown in FIG. 3, an orifice 80 extends through the rotating disc 48 to allow the medium to flow from the hollow cavity 66 of the bushing 64 through a fluid passageway 82, extending through the stationary disc 76 and the bean 78 and exit through the outlet 30. The orifice 80 of the rotating disc 48 can have a first diameter D₁, and the passageway 82 of the stationary disc 76 and the bean 78 can have a second diameter D₂. The first diameter D₁ and the second diameter D₂ can be substantially the same and be about 25 millimeters. In another embodiment, the first diameter D₁ and the second diameter D₂ can each be between about 3 millimeters and about 150 millimeters. The outlet 30 is defined by a third diameter D₃ that is about 97 millimeters. In another embodiment, the third diameter D₃ can be between about 6 millimeters and about 400 millimeters and is substantially larger than the first diameter D₁ and the second diameter D₂, in order to provide a laminar outlet flow 34 to inhibit erosion on the outlet 30. In one embodiment, a ratio D₃/D₂ is about 4. In another embodiment, the ratio D₃/D₂ is between about 1.3 and about 35.

The passageway 82 also defines a length L₁ that can be about 180 millimeters. In another embodiment, the length L₁ can be between about 21 millimeters and about 1,080 millimeters. In the illustrated embodiment, the ratio L₁/D₂ is about 7.2. In another embodiment, the ratio L₁/D₂ is between about 5 and about 15.

As shown in FIG. 3, the orifice 80 of the rotating disc 48 is in a first position 84 and aligned with the passageway 82 to indicate that the choke valve 10 is open. Upon rotation of the turning fork 52, the rotating disc 48 can enter a second position 86, as shown in FIG. 4. The second position 86 is a throttled position due to the orifice 80 of the rotating disc 48 partially overlapping the passageway 82 of the stationary disc 76. Upon further rotation of the turning fork 52, the rotating disc 48 can enter a third position 88. The third position 88 is a closed position due to the orifice 80 of the rotating disc 48 not overlapping the passageway 82 of the stationary disc 76.

There are several advantages to the above described rotating disc principle. First, because the rotating disc 48, the stationary disc 76, and the bean 78 are manufactured out of tungsten carbide, Stellite or Ceramics with sufficient corrosion resistant, anti-eroding and wearable capability, for example, the simple and robust design allow for excellent control and a long service life. Furthermore, the rotating disc 48 enhances easy and low cost maintenance. Another advantage of the rotating disc principle is the protection of the sealing surfaces of the discs against the erosive influence of the medium when the choke valve 10 is in the first open position 84. To provide the required overlap, the choke valve 10 features a rotation angle of 180 degrees between the first open position 84 and the closed position 88. Using this principle, positive shut off can be ensured for an extended service life because the flowing medium does not contact the seat area.

Should erosion occur, a wear monitoring system 90 can be provided to detect the erosion, as shown in FIG. 3. The wear monitoring system 90 can include the pressure sensor 36, an outer depressurized cavity 92, a first cavity seal 94 and a second cavity seal 96. The pressure sensor 36 can extend through a pressure port 98 positioned above the downstream flange 22 of the valve body 12, as shown in FIG. 1. The pressure port 98 extends from an exterior environment of the choke valve 10 to the depressurized cavity 92. In one embodiment, the pressure sensor 36 can be a ROSEMOUNT 2501 or 3051 type pressure sensor to measure a pressure in the depressurized cavity 92.

The depressurized cavity 92 can be defined by the space between the inner surface of the outlet 30 and an outer surface of the bean 78. The first cavity seal 94 can be an o-ring, for example, that is positioned between the inner surface of the outlet 30 and the outer surface of the bean 78 to seal off a bottom portion 100 of the depressurized cavity 92. Similarly, the second cavity seal 96 can be an o-ring, for example, that circumscribes the outer surface of the stationary disc 76 to seal off a top portion 102 of the depressurized cavity 92. Thus, the depressurized cavity 92 forms a sleeve like cavity around the bean 78.

During normal operation of the choke valve 10, the pressure inside the depressurized cavity 92 can be between about 0 PSI and about 15 PSI. If the pressure sensor 36 detects a pressure greater than a predetermined threshold value, for example 60 PSI, a signal is sent to close the choke valve 10 and emergency shutdown (ESD) valves (not shown). This increase in pressure indicates that erosion has caused washing of the bean 78 resulting in the depressurized cavity 92 to become pressurized. A signal can then be sent from the pressure sensor 36 to a remote user interface, for example, to alert a user that the choke valve 10 requires service.

One advantage of the above described choke valve 10 and wear monitoring system 90 is that only the rotating disc 48 and the bean 78 (i.e., internal components) need to be replaced if erosion occurs, and the choke valve 10 remains in service. The valve body 12 is not affected by erosion, as is typically seen in choke valves, because the medium (e.g., fuel) is not filtered causing wear and tear on the outlet 30 piping.

Another advantage is that the passageway 82 of the bean 78 has a diameter D₂ that is less than the diameter D₃ of the outlet 30, causing the outlet flow 34 to be laminar and non-turbulent to limit erosion on the outlet 30 piping. As previously described, the ratio D₃/D₂ is advantageously between about 1.3 and about 35 to provide the laminar outlet flow. However, if erosion does occur, it will occur inside the bean 78 which can be detected by the wear monitoring system 90.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A choke valve comprising:
a valve body defining an inlet and an outlet;
a stationary disc including a bean and defining a passageway arranged between the inlet and outlet of the valve body;
a rotating disc arranged adjacent the stationary disc, the rotating disc movable between an open position and a closed position;
an actuator system coupled to the rotating disc and arranged to actuate the rotating disc between the open position and the closed position; and
a wear monitoring system including a port in communication with a depressurized cavity formed between the valve body and the bean, and a pressure sensor monitoring a pressure in the depressurized cavity.

2. The choke valve of claim 1, wherein the rotating disc includes an orifice configured to align with the passageway of the stationary disc when the rotating disc is in the open position.

3. The choke valve of claim 2, wherein the rotating disc is in at least one of a throttled position and the closed position when the orifice of the rotating disc is misaligned with the passageway of the stationary disc.

4. The choke valve of claim 1, wherein the actuator system includes a shaft extending into a component chamber of the valve body and coupled to a turning fork, the turning fork engaging the rotating disc to provide rotation.

5. The choke valve of claim 4, further comprising a protective bushing arranged in the component chamber of the valve body and surrounding the turning fork and rotating disc.

6. The choke valve of claim 1, wherein the passageway of the stationary disc defines a diameter and length, and a ratio of the length to the diameter of the passageway is between about 5 and about 15.

7. The choke valve of claim 1, wherein the passageway of the stationary disc is defined by a first diameter and the outlet is defined by a second diameter, the first diameter being less than the second diameter.

8. The choke valve of claim 7, wherein a ratio of the second diameter and the first diameter is between about 1.3 and about 35.

9. The choke valve of claim 1, wherein the wear monitoring system further includes a first cavity seal and a second cavity seal to enclose the depressurized cavity, the depressurized cavity defined by a space between an inner surface of the outlet and an outer surface of the bean.

10. The choke valve of claim 1, wherein the pressure sensor is configured to measure the pressure in the depressurized cavity and generate a signal to close the choke valve when the pressure is above a predetermined threshold pressure to indicate the depressurized cavity is pressurized.

11. The choke valve of claim 10, wherein the predetermined threshold pressure is between about 0 PSI and about 15 PSI.

12. The choke valve of claim 10, wherein the rotating disc, the stationary disc, and the bean are replaced when the pressure sensor detects the pressure above the predetermined threshold pressure.

13. A choke valve comprising:
a valve body housing defining an inlet and an outlet defining an outlet diameter;
a rotating disc arranged between the inlet and the outlet and movable between an open position and a closed position; and
a bean positioned adjacent to and downstream of the rotating disc and including a passageway defining a passageway diameter,
wherein a ratio of the outlet diameter to the passageway diameter being between about 1.3 and about 35.

14. The choke valve of claim 13, wherein the ratio of the outlet diameter to the passageway diameter is about 4.

15. The choke valve of claim 13, further comprising a wear monitoring system including a port in communication with a depressurized cavity formed between the valve body and the bean, and a pressure sensor monitoring a pressure in the depressurized cavity.

16. The choke valve of claim 15, wherein the wear monitoring system further includes a first cavity seal and a second cavity seal to enclose the depressurized cavity, the depressurized cavity defined by a space between an inner surface of the outlet and an outer surface of the bean.

17. A choke valve comprising:
a valve body housing defining an inlet and an outlet;
a rotating disc arranged between the inlet and the outlet and movable between an open position and a closed position; and
a bean positioned adjacent to and downstream of the rotating disc and including a passageway defining a passageway diameter and a passageway length,
wherein a ratio of the passageway length to the passageway diameter being between about 5 and about 15.

18. The choke valve of claim 17, wherein the ratio of the passageway length to the passageway diameter is about 7.

19. The choke valve of claim 17, further comprising a wear monitoring system including a port in communication with a depressurized cavity formed between the valve body and the bean, and a pressure sensor monitoring a pressure in the depressurized cavity.

20. The choke valve of claim 19, wherein the wear monitoring system further includes a first cavity seal and a second cavity seal to enclose the depressurized cavity, the depressurized cavity defined by a space between an inner surface of the outlet and an outer surface of the bean.
